(19) United States
(12) Patent Application Publication
(10) Pub. No.: US 2021/0319490 A1
(43) Pub. Date: Oct. 14, 2021

(54) SYSTEM AND METHOD OF SELLING CUSTOMIZED USED CAR

(71) Applicant: AUTOPLUS INC., Seoul (KR)

(72) Inventors: Chong Hwan YI, Seoul (KR); Jae Sung SONG, Seoul (KR); Kyung Dok YANG, Seoul (KR); Sang Ho LEE, Seoul (KR)

(21) Appl. No.: 16/952,558

(22) Filed: Nov. 19, 2020

(30) Foreign Application Priority Data
Apr. 10, 2020 (KR) 10-2020-0043755

(51) Int. Cl. G06Q 30/06; G06Q 30/02; G06Q 10/00; G06Q 10/08; G06Q 10/10; G06Q 30/00; G06Q 40/02

(52) U.S. Cl. CPC G06Q 30/0621; G06Q 30/0278; G06Q 10/20; G06Q 30/0645; B62D 65/005; G06Q 10/10; G06Q 30/018; G06Q 30/0623; G06Q 40/02; G06Q 10/087

(57) ABSTRACT

A system according to an embodiment of the present disclosure is for selling a customized used car on the basis of information selected by a customer. The system may include an inspection terminal receiving score data for each inspection item of a warehoused car from an inspector, a customer terminal receiving car-type selection information and repair-request selection information from the customer, and a used-car sale server calculating a total score that represents condition of the warehoused car, by using the score data for each inspection item of the warehoused car, and transmitting, to the customer terminal, car price information that is calculated on the basis of the repair-request selection information and the total score corresponding to the car-type selection information among the total scores for the respective warehoused cars.

### CROSS REFERENCE TO RELATED APPLICATION

The present application claims priority to Korean Patent Application No. 10-2020-0043755, filed Apr. 10, 2020, the entire contents of which is incorporated herein for all purposes by this reference.

### BACKGROUND

### 1. Field of the Invention

The present disclosure relates to a system and a method of selling a customized used car. In particular, the present disclosure relates to a system and a method of selling a customized used car on the basis of repair-request selection information that a customer provides.

### 2. Description of the Related Art

As used-car transactions have become common in Korea, commercial transactions through the Internet and auctions have been actively conducted. However, regarding such used car transactions, some used-car transaction corporations have falsified the conditions or the performance evaluations of the used cars they sold. This has reduced the consumer trust in the performance of the used car.

Problems with the performance of the used cars and used-car transactions have begun to be known through mass media. As a result, this has brought distrust of the reliability, the transparency, the objectivity, the fairness, and the like in the used car. Accordingly, the used-car market has shrunk.

A conventional system for selling a used car has been unable to provide objective information regarding performance evaluation, and has provided only information on car price including repair costs for use.

Therefore, there is a need for a technology that is capable of providing a consumer with highly reliable performance evaluation information, and with information on the price of a customized car on the basis of repair-request selection information.

The foregoing is intended merely to aid in the understanding of the background of the present disclosure, and is not intended to mean that the present disclosure falls within the purview of the related art that is already known to those skilled in the art.

### SUMMARY

The present disclosure is directed to providing a system and a method of selling a customized used car, the system and the method being capable of providing a consumer with highly reliable performance evaluation information, and with car price information on the basis of repair-request selection information.

According to an embodiment, there is provided a system for selling a customized used car on the basis of information selected by a customer. The system for selling a customized used car includes: an inspection terminal receiving score data for each inspection item of a warehoused car from an inspector; a customer terminal receiving car-type selection information and repair-request selection information from the customer; and a used-car sale server calculating a total score that represents condition of the warehoused car, by using the score data for each inspection item of the warehoused car, and transmitting, to the customer terminal, car price information that is calculated on the basis of the repair-request selection information and the total score corresponding to the car-type selection information among the total scores for the respective warehoused cars.

The score data for each inspection item of the warehoused car may include transparency score data, safety score data, driving performance score data, oil-leak score data, eco-friendly score data, and repair target score data; and the transparency score data, the safety score data, the driving performance score data, the oil-leak score data, the eco-friendly score data, and the repair target score data each may include scores for respective multiple items.

The used-car sale server may be configured to, convert the scores for the respective items of the transparency score data, the safety score data, the driving performance score data, the oil-leak score data, the eco-friendly score data, and the repair target score data into percentage scores, multiply preset weightings and average scores of the percentage scores for the respective items of the transparency score data, the safety score data, the driving performance score data, the oil-leak score data, and the eco-friendly score data, respectively so as to calculate the transparency score data, the safety score data, the driving performance score data, the oil-leak score data, and the eco-friendly score data, respectively, and multiply preset weightings and the percentage scores for the respective items of the repair target score data so as to calculate the repair target score data.

The used-car sale server may be configured to, multiply a preset weighting and a value acquired by adding all the transparency score data, the safety score data, the driving performance score data, the oil-leak score data, and the eco-friendly score data so as to calculate a first median value, multiply a preset weighting and the repair target score data so as to calculate a second median value, and add the first median value and the second median value so as to calculate the total score.

According to an embodiment, there is provided a method of selling a customized used car on the basis of information selected by a customer. The method of selling a customized used car includes: receiving, by an inspection terminal, score data for each inspection item of a warehoused car from an inspector; receiving, by a customer terminal, car-type selection information and repair-request selection information from the customer; calculating, by a used-car sale server, a total score that represents condition of the warehoused car, by using the score data for each inspection item of the warehoused car; and transmitting, to the customer terminal by the used-car sale server, car price information that is calculated on the basis of the repair-request selection information and the total score corresponding to the car-type selection information among the total scores for the respective warehoused cars.

The highly reliable performance evaluation information is provided to a consumer and information on the price of a customized car is provided on the basis of repair-request selection information, thereby leading the consumer to spend wisely.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram illustrating a system for selling a customized used car according to an embodiment;

FIGS. 2 and 3 are diagrams illustrating score data for each inspection item of a car according to an embodiment;

FIG. 4 is a diagram illustrating a screen of a customer terminal according to an embodiment;

FIG. 5 is a diagram illustrating score data for each inspection item of a car according to an embodiment;

FIG. 6 is a diagram illustrating a screen of a customer terminal according to an embodiment; and

FIG. 7 is a flowchart illustrating a method of selling a customized used car according to an embodiment.

### DETAILED DESCRIPTION OF THE INVENTION

Hereinbelow, embodiments of the present disclosure will be described in detail with reference to the accompanying drawings such that the present disclosure can be easily embodied by those skilled in the art to which this present disclosure belongs. However, the present disclosure may be embodied in various different forms and should not be limited to the embodiments set forth herein. In order to clearly describe the present disclosure, parts not related to the description are omitted, and similar elements are denoted by similar reference numerals throughout the specification.

Throughout the specification, when a part “includes” an element, it is noted that it further includes other elements, but does not exclude other elements, unless specifically stated otherwise.

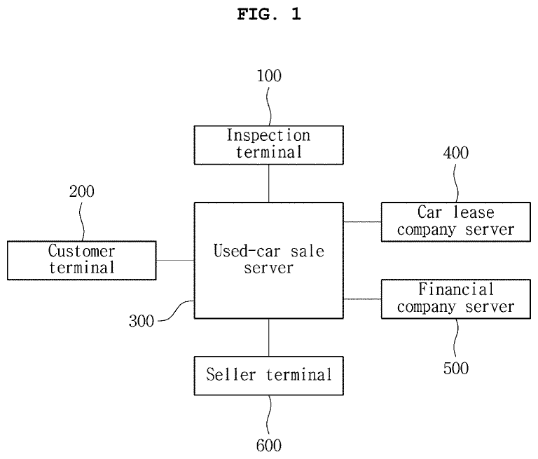

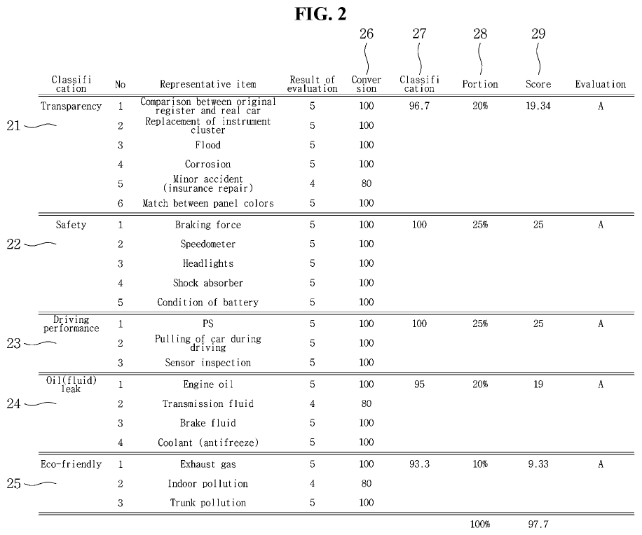

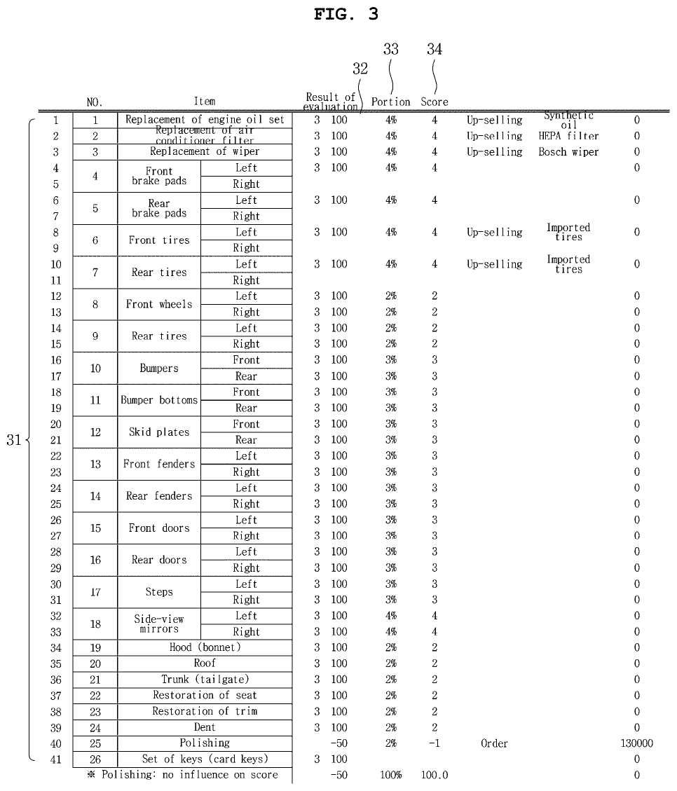

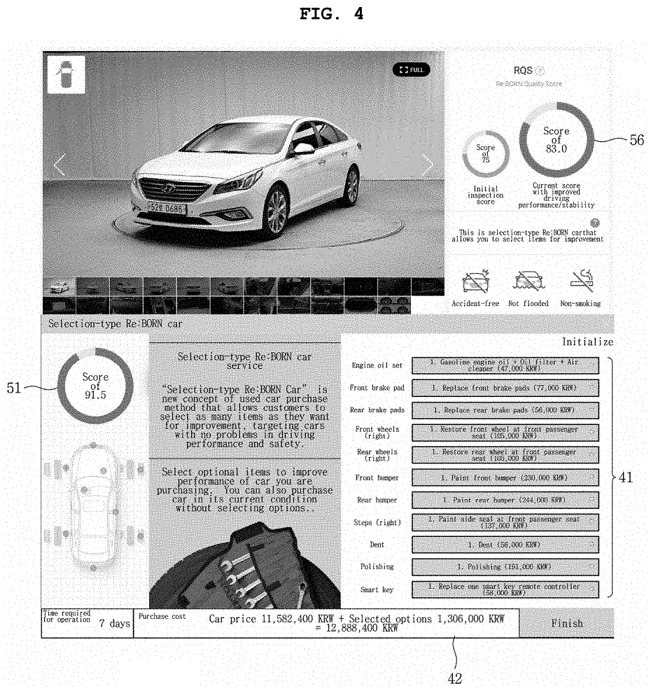

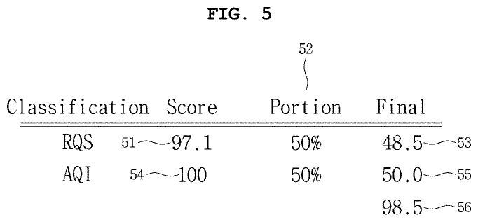

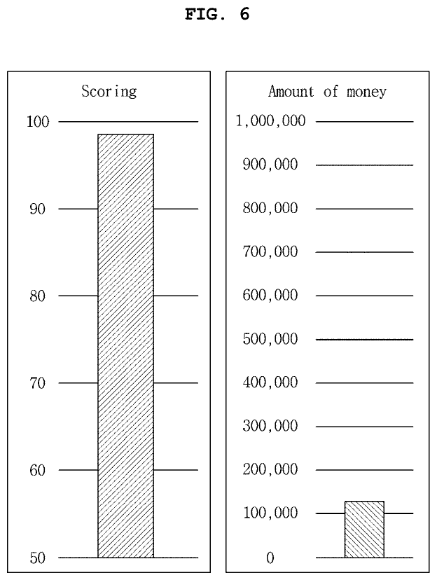

FIG. 1 is a block diagram illustrating a system for selling a customized used car according to an embodiment. FIGS. 2 and 3 are diagrams illustrating score data for each inspection item of a car according to an embodiment. FIG. 4 is a diagram illustrating a screen of a customer terminal according to an embodiment. FIG. 5 is a diagram illustrating score data for each inspection item of a car according to an embodiment. FIG. 6 is a diagram illustrating a screen of a customer terminal according to an embodiment.

Referring to FIG. 1, according to an embodiment, a system for selling a customized used car may include an inspection terminal 100, a customer terminal 200, a used-car sale server 300, a car lease company server 400, a financial company server 500, and a seller terminal 600.

The inspection terminal 100 receives score data for each inspection item of a warehoused car from an inspector. The inspector conducts inspection as a car is warehoused, and inputs score data for each inspection item of the warehoused car through the inspection terminal 100.

As an embodiment, the inspection terminal 100 may be a digital device equipped with a memory means and a microprocessor to have computing power, for example, a mobile communication terminal, a desktop computer, a laptop computer, a workstation, a palmtop computer, a personal digital assistant (PDA), a web pad, or the like.

Referring to FIGS. 2 and 3, the score data for each inspection item of the warehoused car may include transparency score data 21, safety score data 22, driving performance score data 23, oil-leak score data 24, eco-friendly score data 25, and repair target score data 31.

As an embodiment, the transparency score data 21, the safety score data 22, the driving performance score data 23, the oil-leak score data 24, the eco-friendly score data 25, and the repair target score data 31 each may include scores for respective multiple items.

As an embodiment, the transparency score data 21 may include a score based on a result of comparison with an original register, a score based on whether an instrument cluster has been replaced, a score based on whether the warehoused car has been flooded, a score based on whether corrosion has occurred, a score based on whether a minor accident has occurred, and a score based on whether colors of a panel match.

As an embodiment, the safety score data 22 may include a score for braking force, a score for condition of a speedometer, a score for condition of headlights, a score for condition of a shock absorber, and a score for condition of a battery.

As an embodiment, the driving performance score data 23 may include a score for horsepower (PS), a score based on whether the car pulls during driving, and a score for condition of a sensor.

As an embodiment, the oil-leak score data 24 may include a score based on whether an engine oil leak occurs, a score based on whether a transmission fluid leak occurs, a score based on whether a brake fluid leak occurs, and a score based on whether a coolant or antifreeze leak occurs.

As an embodiment, the eco-friendly score data 25 may include a score based on whether exhaust gas is emitted, a score based on a numerical value of indoor pollution, and a score based on whether a trunk has been polluted.

As an embodiment, the repair target score data 31 may include the following: a score based on whether a set regarding to engine oil is to be replaced, a score based on whether an air conditioner filter is to be replaced, a score based on whether a wiper is to be replaced, a score for condition of left and right front brake pads, a score for condition of left and right rear brake pads, scores for condition of left and right front wheels, scores for condition of left and right rear wheels, scores for condition of front and rear bumpers, scores for condition of front and rear bumper bottoms, scores for condition of front and rear skid plates, scores for condition of left and right front fenders, scores for condition of left and right rear fenders, scores for condition of left and right front doors, scores for condition of left and right rear doors, scores for condition of left and right steps, scores for condition of left and right side-view mirrors, a score for condition of a hood (bonnet), a score for condition of a roof, a score for condition of a trunk (tailgate), a score based on whether a seat is to be restored, a score based on whether a trim is to be restored, a score based on whether a dent is to be removed, a score based on whether polishing is to be performed, and a score based on whether a set of keys (card keys) is present.

The customer terminal 200 may receive car-type selection information (information on a car-type selection) and repair-request selection information (information on a repair-request selection) from the customer. Referring to FIG. 4, the customer may select, through the customer terminal 200, a type of car and a repair-request item 41.

As an embodiment, the customer terminal 200 may be a digital device equipped with a memory means and a microprocessor to have computing power, for example, a mobile communication terminal, a desktop computer, a laptop computer, a workstation, a palmtop computer, a personal digital assistant (PDA), a web pad, or the like.

Referring to FIGS. 2 and 3, the used-car sale server 300 uses score data for each inspection item of the warehoused car so as to calculate a total score that represents the condition of the warehoused car. The used-car sale server 300 transmits, to the customer terminal, car price information that is calculated on the basis of the repair-request selection information and the total score corresponding to the car-type selection information among the total scores for the respective warehoused cars.

Specifically, the used-car sale server 300 converts the scores for the respective items of the transparency score data 21, the safety score data 22, the driving performance score data 23, the oil-leak score data 24, and the eco-friendly score data 25 into percentage scores 26, respectively, and converts the scores for the respective items of the repair target score data 31 into percentage scores, respectively.

The used-car sale server 300 multiplies preset first weightings 28 and average scores 27 of the percentage scores for the respective items of the transparency score data 21, the safety score data 22, the driving performance score data 23, the oil-leak score data 24, and the eco-friendly score data 25, respectively so that percentage scores 29 of the transparency score data 21, the safety score data 22, the driving performance score data 23, the oil-leak score data 24, and the eco-friendly score data 25 are calculated, respectively.

When the percentage scores 29 of the transparency score data 21, the safety score data 22, the driving performance score data 23, the oil-leak score data 24, and the eco-friendly score data 25 are equal to or greater than 90, the used-car sale server 300 converts the percentage scores 29 into an “A” grade. When the percentage scores 29 are equal to or greater than 80 and smaller than 90, the used-car sale server 300 converts the percentage scores 29 into a “B” grade. When the percentage scores 29 are equal to or greater than 70 and smaller than 80, the used-car sale server 300 converts the percentage scores 29 into a “C” grade. When the percentage scores 29 are smaller than 70, the used-car sale server 300 converts the percentage scores 29 into a “D” grade. The first weightings 28 may have various values depending on a setting.

The used-car sale server 300 multiplies preset second weightings 33 and percentage scores 32 for the respective items of the repair target score data 31 so that percentage scores 34 of the repair target score data are calculated. The second weightings 33 may have various values depending on a setting.

Referring to FIGS. 2, 3, and 5, the used-car sale server 300 multiplies a preset third weighting 52 and a value 51 acquired by adding all the percentage scores of the transparency score data 21, the safety score data 22, the driving performance score data 23, the oil-leak score data 24, and the eco-friendly score data 25, thereby calculating a first median value 53. The used-car sale server 300 multiplies a preset third weighting 52 and a value 54 acquired by adding all the percentage scores of the repair target score data 31, thereby calculating a second median value 55. The used-car sale server 300 adds the first median value 53 and the second median value 55, thereby calculating a total score 56. The third weightings 52 may have various values depending on a setting.

Referring to FIG. 6, the used-car sale server 300 displays, in an alphabet grade or a bar graph on the screen of the customer terminal 200, car price information that is calculated on the basis of the repair-request selection information and the total score 56 corresponding to the car-type selection information. As an embodiment, the used-car sale server 300 displays, on the screen of the customer terminal 200, the alphabet grades of the transparency score data 21, the safety score data 22, the driving performance score data 23, the oil-leak score data 24, and the eco-friendly score data 25. Referring to FIG. 4, as an embodiment, the used-car sale server 300 may display, on the screen of the customer terminal 200, the value 51 acquired by adding all the percentage scores of the transparency score data 21, the safety score data 22, the driving performance score data 23, the oil-leak score data 24, and the eco-friendly score data 25; the total score 56; and the car price information 42 calculated on the basis of the total score 56 and the repair-request selection information.

The car lease company server 400 may transmit information on a warehoused car to the used-car sale server 300. As an embodiment, the used-car sale server 300 may receive the information on the warehoused car from the car lease company server 400 or the seller terminal 600. As an embodiment, the seller terminal 600 may be a digital device equipped with a memory means and a microprocessor to have computing power, for example, a mobile communication terminal, a desktop computer, a laptop computer, a workstation, a palmtop computer, a personal digital assistant (PDA), a web pad, or the like.

The financial company server 500 may receive information on a financial product agreement from the used-car sale server 300. As an embodiment, the financial company server 500 may be one among a bank server, a credit card company server, and an insurance company server.

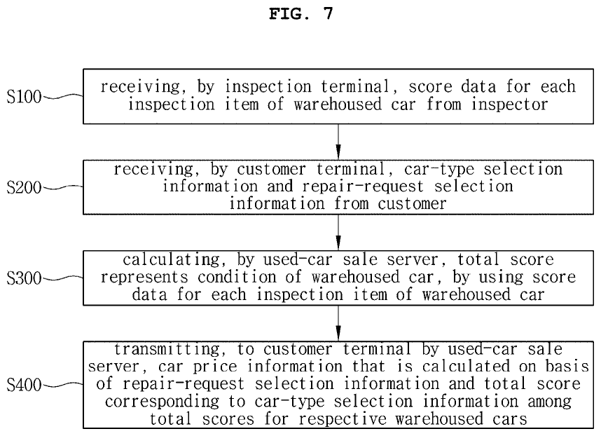

FIG. 7 is a flowchart illustrating a method of selling a customized used car according to an embodiment.

Referring to FIG. 7, according to an embodiment, there is provided a method of selling a customized used car, the method including: receiving, by an inspection terminal, score data for each inspection item of a warehoused car from the inspector at step S100; receiving, by a customer terminal, car-type selection information and repair-request selection information from a customer at step S200; calculating, by a used-car sale server, a total score that represents condition of the warehoused car, by using the score data for each inspection item of the warehoused car at step S300; and transmitting, to the customer terminal by the used-car sale server, car price information that is calculated on the basis of the repair-request selection information and the total score corresponding to the car-type selection information among the total scores for the respective warehoused cars at step S400.

The method of selling the customized used car includes: receiving, by the inspection terminal 100, score data for each inspection item of a warehoused car from an inspector at step S100; receiving, by the customer terminal 200, car-type selection information and repair-request selection information from a customer at step S200; calculating, by the used-car sale server 300, a total score that represents condition of the warehoused car, by using the score data for each inspection item of the warehoused car at step S300; and transmitting, to the customer terminal 200 by the used-car sale server 300, car price information that is calculated on the basis of the repair-request selection information and the total score corresponding to the car-type selection information among the total scores for the respective warehoused cars at step S400. The method is the same as the above-described details of operations of the inspection terminal 100, the customer terminal 200, and the used-car sale server 300, and thus a detailed description of the method will be omitted.

Although the embodiments of the present disclosure have been described in detail, the scope of the present disclosure is not limited thereto. The scope of the present disclosure also includes various modifications and improvements by those skilled in the art that use the fundamental conception of the present disclosure defined in the following claims.

1. A system for selling a customized used car based on information selected by a customer, the system comprising:
an inspection terminal comprising a memory and a microprocessor configured to receive score data for each inspection item of a warehoused car from an inspector;
a customer terminal comprising a memory and a microprocessor configured to receive car-type selection information and repair-request selection information from the customer;
a used-car sale server calculating a total score that represents a condition of the warehoused car, by using the score data of the warehoused car, and transmitting, to the customer terminal, information that is calculated based on the repair-request selection information and the total score corresponding to the car-type selection information among the total scores for the respective warehoused cars,
a car lease company server transmitting information on the warehoused cars to the used-car sale server; and
a financial company server receiving information on a financial product agreement from the used-car sale server,
wherein the score data for each inspection item of the warehoused car includes transparency score data, safety score data, driving performance score data, oil-leak score data, eco-friendly score data, and repair target score data;
the transparency score data includes a score based on a result of comparison with an original register, a score based on whether an instrument cluster has been replaced, a score based on whether the warehoused car has been flooded, a score based on whether corrosion has occurred, a score based on whether a minor accident has occurred, and a score based on whether colors of a panel match;
the safety score data includes a score for braking force, a score for condition of a speedometer, a score for condition of headlights, a score for condition of a shock absorber, and a score for condition of a battery;
the driving performance score data includes a score for horsepower, a score based on whether the car pulls during driving, and a score for condition of a sensor;
the oil-leak score data includes a score based on whether an engine oil leak occurs, a score based on whether a transmission fluid leak occurs, a score based on whether a brake fluid leak occurs, and a score based on whether a coolant or antifreeze leak occurs;
the eco-friendly score data includes a score based on whether exhaust gas is emitted, a score based on a numerical value of indoor pollution, and a score based on whether a trunk has been polluted; and
the used-car sale server is configured to:
display, in an alphabet grade or a bar graph on a screen of the customer terminal, the warehoused car price information that is calculated on the basis of the repair-request selection information and the total score corresponding to the car-type selection information,
convert the scores for respective items of the transparency score data, the safety score data, the driving performance score data, the oil-leak score data, the eco-friendly score data, and scores for respective items of the repair target score data into percentage scores, and
compare the percentage scores of the transparency score data, the safety score data, the driving performance score data, the oil-leak score data, and the eco-friendly score data with preset reference values so as to convert the percentage scores into alphabet grades corresponding to the respective preset reference values.
wherein the used-car sale server is configured to:
convert the scores for the respective items of the transparency score data, the safety score data, the driving performance score data, the oil-leak score data, the eco-friendly score data, and the repair target score data into the percentage scores;
multiply preset weightings and average scores of the percentage scores for the respective items of the transparency score data, the safety score data, the driving performance score data, the oil-leak score data, and the eco-friendly score data, respectively so as to calculate the transparency score data, the safety score data, the driving performance score data, the oil-leak score data, and the eco-friendly score data, respectively;
multiply preset weightings and the percentage scores for the respective items of the repair target score data so as to calculate the repair target score data, and wherein the used-car sale server is configured to:
multiply a preset weighting and a value acquired by adding all the transparency score data, the safety score data, the driving performance score data, the oil-leak score data, and the eco-friendly score data so as to calculate a first median value;
multiply a preset weighting and the repair target score data so as to calculate a second median value; and
add the first median value and the second median value so as to calculate the total score.

2. (canceled)

3. (canceled)
